(19) United States
(12) Patent Application Publication
(10) Pub. No.: US 2024/0306200 A1
(43) Pub. Date: Sep. 12, 2024

(54) MECHANISM FOR SPEEDING UP RADAR DETECTION FOR 5GHZ FULL-BAND

(71) Applicant: MEDIATEK INC., Hsin-Chu (TW)

(72) Inventor: Ming-Wang Guo, Hsinchu City (TW)

(73) Assignee: MEDIATEK INC., Hsin-Chu (TW)

(21) Appl. No.: 18/587,989

(22) Filed: Feb. 27, 2024

Related U.S. Application Data
(60) Provisional application No. 63/489,224, filed on Mar. 9, 2023.

(51) Int. Cl. H04W 74/0808; G01S 7/02

(52) U.S. Cl. CPC H04W 74/0808; G01S 7/021

(57) ABSTRACT

The present invention provides a control method of an electronic device, wherein the electronic device includes a first antenna group and a second antenna, and the control method includes: using a first channel to communicate with other electronic device(s) via the first antenna group; performing a CAC process to detect if any radar signal appears in all DFS channels in a 5 GHz band during a CAC period by using at least the second antenna, to generate a radar detection result; and determining a second channel according to the radar detection result, and using the second channel to communicate with the other electronic device(s) via the first antenna group.

### CROSS REFERENCE TO RELATED APPLICATIONS

This application claims the benefit of U.S. Provisional Application No. 63/489,224, filed on Mar. 9, 2023. The content of the application is incorporated herein by reference.

### BACKGROUND

Dynamic frequency selection (DFS) is a function of using Wi-Fi 5 GHz band that are generally reserved for radar, such as military radar, satellite communication, and weather radar. It is legally required channel availability check (CAC) process to prevent electromagnetic interference the 5 GHz frequency with the radar.

During normal operations, if an access point (AP) detects that a radar is using the particular channel which is currently used by the AP, it may communicated to the connected Wi-Fi stations to stop the transmission and change to another available channel together. This behavior will cause connected Wi-Fi stations to be disconnected from the network for a period of time before re-connecting to a different channel, causing inconvenience to the users.

In order to solve this problem, a zero-wait DFS mechanism is provided to shorten the service interruption time when switching from the DFS channels and reduces the discomfort of the user experience. This zero-wait DFS mechanism is to use another antenna (also called zero-wait antenna) and continuously monitor radar signals, and if the DFS channel radar signals, the AP can quickly switch to other channels.

However, in the conventional art using the zero-wait DFS mechanism, only a portion of bandwidth, such as 160 MHz, in the 5 GHz band is detected during a CAC period (e.g. 1-10 minutes). If a radar signal is detected in this portion of bandwidth, all the channels within this portion of bandwidth cannot be used within a period of time, such as thirty minutes, and another portion of bandwidth in the 5 GHz band is detected during a next CAC period. Therefore, the conventional art is not efficient in channel usage and CAC process, so it will cause inconvenience to users.

### SUMMARY

It is therefore an objective of the present invention to provide a control method of the AP, which can speed up radar detection for 5 GHz full-band, to solve the above-mentioned problems.

According to one embodiment of the present invention, a control method of an electronic device is disclosed, wherein the electronic device comprises a first antenna group and a second antenna, and the control method comprises: using a first channel to communicate with other electronic device(s) via the first antenna group; performing a CAC process to detect if any radar signal appears in all DFS channels in a 5 GHz band during a CAC period by using at least the second antenna, to generate a radar detection result; and determining a second channel according to the radar detection result, and using the second channel to communicate with the other electronic device(s) via the first antenna group.

According to one embodiment of the present invention, a control method of an electronic device is disclosed, wherein the electronic device comprises a first antenna group and a second antenna, and the control method comprises: using a first channel to communicate with other electronic device(s) via the first antenna group; performing a CAC process to detect if any radar signal appears in at least a portion of DFS channels in a 5 GHz band during a CAC period by using the second antenna, to generate a radar detection result, wherein at least the portion of DFS channels in the 5 GHz band has at least 240 MHz bandwidth; and determining a second channel according to the radar detection result, and using the second channel to communicate with the other electronic device(s) via the first antenna group.

According to one embodiment of the present invention, an electronic device comprising a first antenna group, a second antenna and a wireless communication circuit is disclosed. The wireless communication circuit is configured to perform the steps of: using a first channel to communicate with other electronic device(s) via the first antenna group; performing a CAC process to detect if any radar signal appears in all DFS channels in a 5 GHz band during a CAC period by using at least the second antenna, to generate a radar detection result; and determining a second channel according to the radar detection result, and using the second channel to communicate with the other electronic device(s) via the first antenna group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device such as an AP according to one embodiment of the present invention.

FIG. 2 shows a plurality of channels with different bandwidths.

FIG. 3 is a configuration of the main antenna and the zero-wait antenna according to one embodiment of the present invention.

FIG. 4 is a diagram illustrating operations of the AP according to a first embodiment of the present invention.

FIG. 5 is a diagram illustrating operations of the AP according to a second embodiment of the present invention.

FIG. 6 is a diagram illustrating operations of the AP according to a third embodiment of the present invention.

FIG. 7 is a diagram illustrating a control method of the AP according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

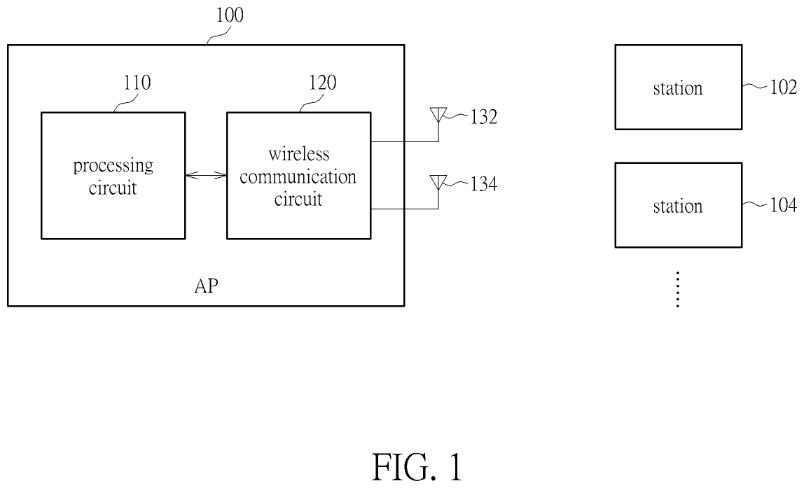

FIG. 1 is a diagram illustrating an electronic device such as an AP 100 according to one embodiment of the present invention. As shown in FIG. 1, the AP 100 comprises a processing circuit 110 and a wireless communication circuit 120, wherein the wireless communication circuit 120 comprises at least a media address control (MAC) layer circuit and physical layer circuit, and the AP 100 is configured to wirelessly communicate with at least one station such as stations 102 and 104.

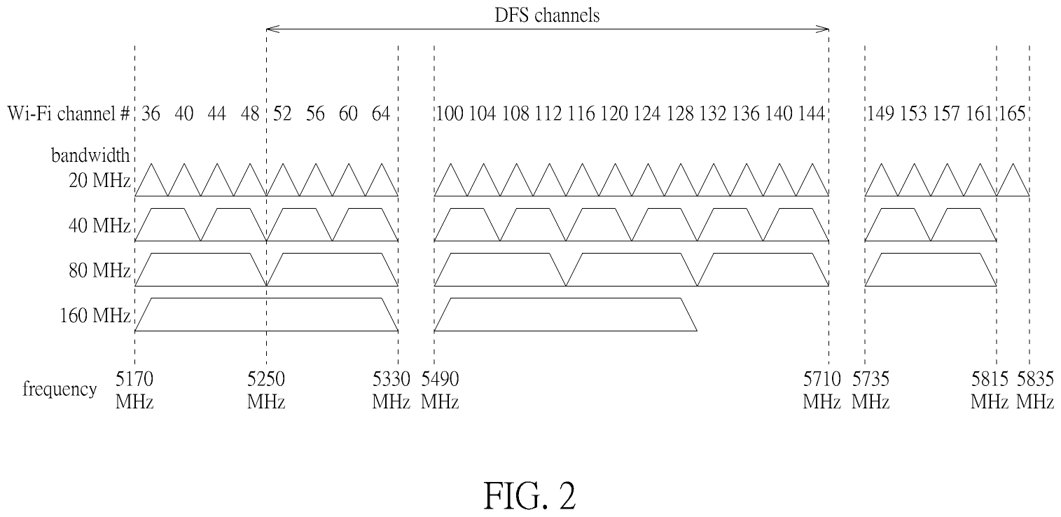

In this embodiment, the AP 100 can communicate the corresponding stations by using at least one link, wherein the link may use a channel corresponding to a 2.4 GHz band (e.g., 2.412 GHz-2.484 GHz), a 5 GHz band (e.g., 4.915 GHz-5.825 GHz) or a 6 GHz band (e.g., 5.925 GHz-7.125 GHz). In addition, the AP 100 uses a channel bonding mechanism defined in IEEE 802.11 specification, that is the AP 100 can bond two or more adjacent Wi-Fi channels (20 MHz channel) to create a wider bandwidth channel to increase the throughput in wireless networks. Taking FIG. 2 as an example, the AP 100 can bond the 20 MHz Wi-Fi channels #36, #40, #44 and #48 to create 80 MHz channel bandwidth; or the AP 100 can bond the 20 MHz Wi-Fi channels #100, #104, #108 and #112 to create 80 MHz bandwidth of channel bandwidth; or the AP 100 can bond the 20 MHz Wi-Fi channels #36, #40, #44, #48, #52, #56, #60 and #64 to create 160 MHz channel bandwidth; or the AP 110/120 can bond the 20 MHz Wi-Fi channels #100, #104, #108, #112, #116, #120, #124 and #128 to create 160 MHz channel bandwidth. In addition, when the channel has the 40 MHz, 80 MHz or 160 MHz bandwidth, each 20 MHz Wi-Fi channel included in the channel whose bandwidth is 40 MHz, 80 MHz or 160 MHz can be called a Wi-Fi sub-channel.

As shown in FIG. 2, the Wi-Fi channels #52-#144 are DFS channels. If the AP 100 detects that a radar is using the particular channel which is currently used, the AP 100 needs to notify the connected stations 102 and 104 to stop the transmission and change to another available channel together. In order to shorten the service interruption time when switching from the DFS channels and reduces the discomfort of the user experience, a zero-wait DFS mechanism can be used to continuously monitor radar signals, and if the DFS channel radar signals, the AP 100 can quickly switch to other channels. It is noted that the zero-wait DFS is known by a person skilled in the art, and the present invention focuses on the channel detection and channel selection mechanism, so the detailed operations of the zero-wait DFS mechanism is omitted in this description.

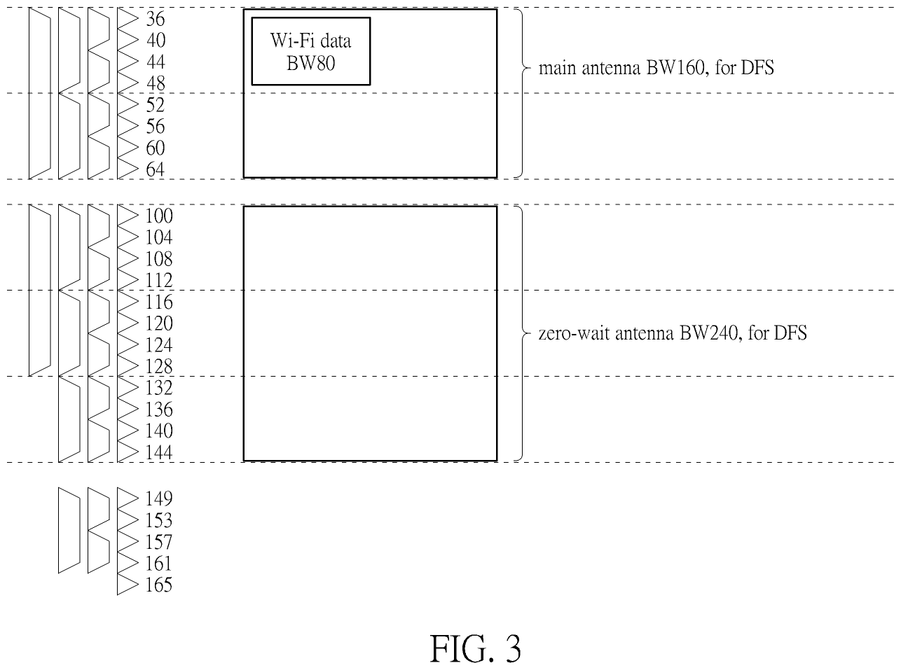

Because of the use of the zero-wait DFS mechanism, the AP 100 has a first antenna group and a second antenna, wherein the first antenna group comprises at least one main antenna 132, and the second antenna is a zero-wait antenna 134. It is noted that FIG. 1 shows only one main antenna 132 for simplicity, and in practice, the first antenna group generally has two or more antennas. Referring to FIG. 3, the wireless communication circuit 120 is configured to communicate with the stations 102 and 104 via a channel with 20 MHz, 40 MHz, 80 MHz or 160 MHz shown in FIG. 2 via the main antenna 132, to transmit/receive valid Wi-Fi data. It is noted that the channel having Wi-Fi sub-channels #36, #40, #44 and #48 is for illustrative. In addition, the wireless communication circuit 120 is further configured to continuously monitor the Wi-Fi sub-channels #52, #56, #60 and #64 via the main antenna 132, to detect if any one of the Wi-Fi sub-channels #52, #56, #60 and #64 has radar signals. The wireless communication circuit 120 is further configured to continuously monitor the Wi-Fi sub-channels #100-#144 (i.e., 240 MHz bandwidth) via the zero-wait antenna 134, to detect if any one of the Wi-Fi sub-channels #100-#144 has radar signals.

In addition, the wireless communication circuit 120 may comprise many detection engines for each Wi-Fi sub-channel, so that it is able to identify the radar signals in each Wi-Fi sub-channel.

It is noted that the embodiment shown in FIG. 3 is for illustrative, not a limitation of the present invention. In another embodiment, the zero-wait antenna 134 can be used to continuously monitor the Wi-Fi sub-channels #52-#144 (i.e., 320 MHz bandwidth), and the main antenna 132 is not used for radar signal detection.

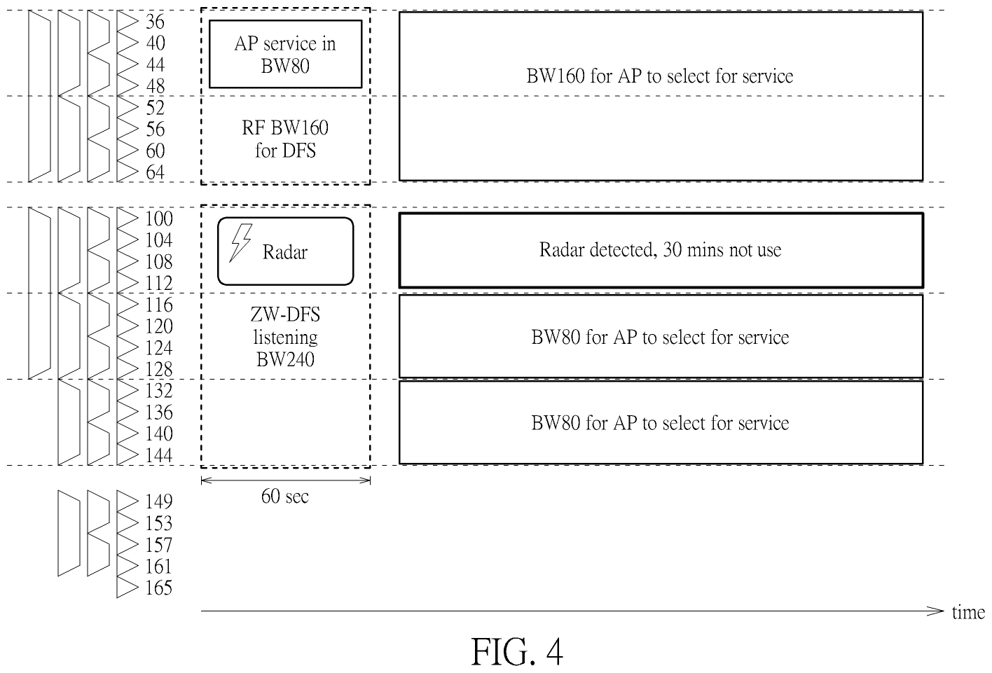

FIG. 4 is a diagram illustrating operations of the AP 100 according to a first embodiment of the present invention. As shown in FIG. 4, assuming that the AP 100 is just powered on, and initially the wireless communication circuit 120 starts to operate in a power-on mode. In the power-on mode, it is currently unclear whether there is a radar signal on the DFS channels, so the AP 100 uses a channel not belonging to the DFS channels to communicate with the stations 102 and 104 (FIG. 4 shows that the channel having Wi-Fi sub-channels #36-#48 is used), and the wireless communication circuit 120 starts to perform a CAC process to detect if any radar signal appears in the DFS channels during a CAC period such as 60 seconds. Specifically, during the CAC period, the wireless communication circuit 120 receives a signal via the main antenna 132 to detect if a radar signal appears in the Wi-Fi sub-channels #52-#64, and the communication circuit 120 further receives a signal via the zero-wait antenna 134 to detect if a radar signal appears in the Wi-Fi sub-channels #100-#144. In this embodiment, the wireless communication circuit 120 detects that the Wi-Fi sub-channels #52-#64 have the radar signals within the CAC period, so the Wi-Fi sub-channels #52-#64 cannot be used to communicate with the stations 102 and 104 for a period of time (e.g., within the next 30 minutes). In addition, because the Wi-Fi sub-channels #52-#64 and the Wi-Fi sub-channels #116-#114 do not have the radar signals, the wireless communication circuit 120 can select the channel having Wi-Fi sub-channels #36-#64 with 160 MHz bandwidth, or the wireless communication circuit 120 can select the channel having Wi-Fi sub-channels #116-#128 with 80 MHz bandwidth, or the wireless communication circuit 120 can select the channel having Wi-Fi sub-channels #132-#144 with 80 MHz bandwidth, for communicating with the stations 102 and 104. That is, after the CAC period, the wireless communication circuit 120 selects an appropriate channel according to a radar detection result obtained in the CAC process, and uses the selected channel to communicate with the stations 102 and 104 via the main antenna 132. It is noted that, after the CAC period, the wireless communication circuit 120 switches to a radar detection mode from the power-on mode, and the wireless communication circuit 120 continuously monitor the DFS channels to detect if any radar signal appears via the main antenna 132 and the zero-wait antenna 134.

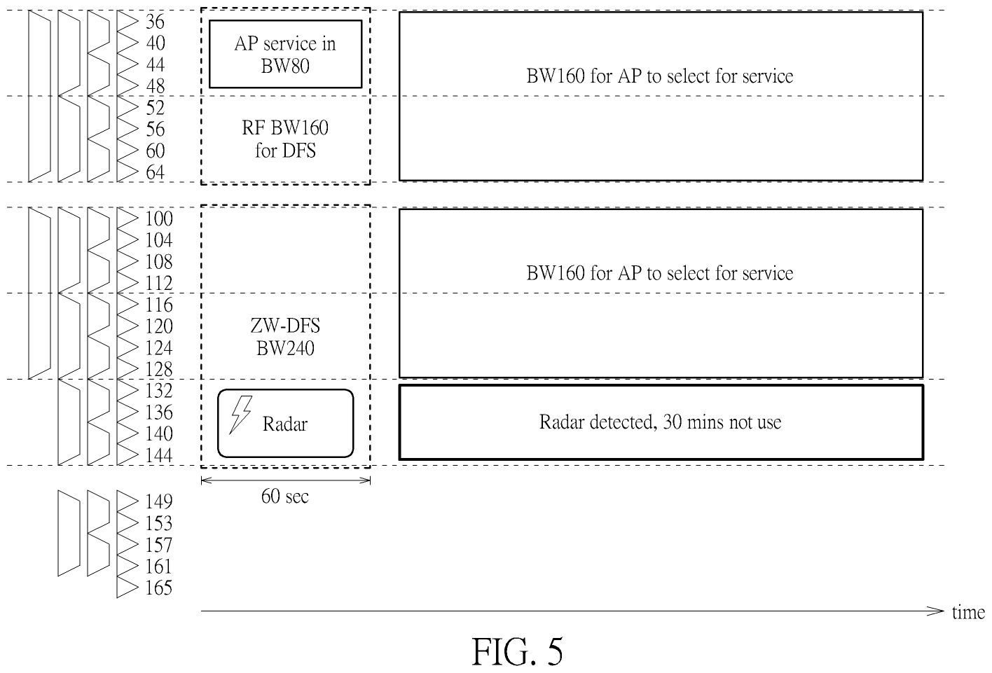

FIG. 5 is a diagram illustrating operations of the AP 100 according to a second embodiment of the present invention. As shown in FIG. 5, assuming that the AP 100 is just powered on, and initially the wireless communication circuit 120 starts to operate in a power-on mode. In the power-on mode, it is currently unclear whether there is a radar signal on the DFS channels, so the AP 100 uses a channel bot belonging to the DFS channels to communicate with the stations 102 and 104 (FIG. 5 shows that the channel having Wi-Fi sub-channels #36-#48 is used), and the wireless communication circuit 120 starts to perform a CAC process to detect if any radar signal appears in the DFS channels during a CAC period such as 60 seconds. Specifically, during the CAC period, the wireless communication circuit 120 receives a signal via the main antenna 132 to detect if a radar signal appears in the Wi-Fi sub-channels #52-#64, and the communication circuit 120 further receives a signal via the zero-wait antenna 134 to detect if a radar signal appears in the Wi-Fi sub-channels #100-#144. In this embodiment, the wireless communication circuit 120 detects that the Wi-Fi sub-channels #132-#144 have the radar signals within the CAC period, so the Wi-Fi sub-channels #132-#144 cannot be used to communicate with the stations 102 and 104 within the next 30 minutes. In addition, because the Wi-Fi sub-channels #52-#64 and the Wi-Fi sub-channels #100-#128 do not have the radar signals, the wireless communication circuit 120 can select the channel having Wi-Fi sub-channels #36-#64 with 160 MHz bandwidth, or the wireless communication circuit 120 can select the channel having Wi-Fi sub-channels #100-#128 with 160 MHz bandwidth, for communicating with the stations 102 and 104. In addition, after the CAC period, the wireless communication circuit 120 switches to the radar detection mode from the power-on mode, and the wireless communication circuit 120 continuously monitor the DFS channels to detect if any radar signal appears via the main antenna 132 and the zero-wait antenna 134.

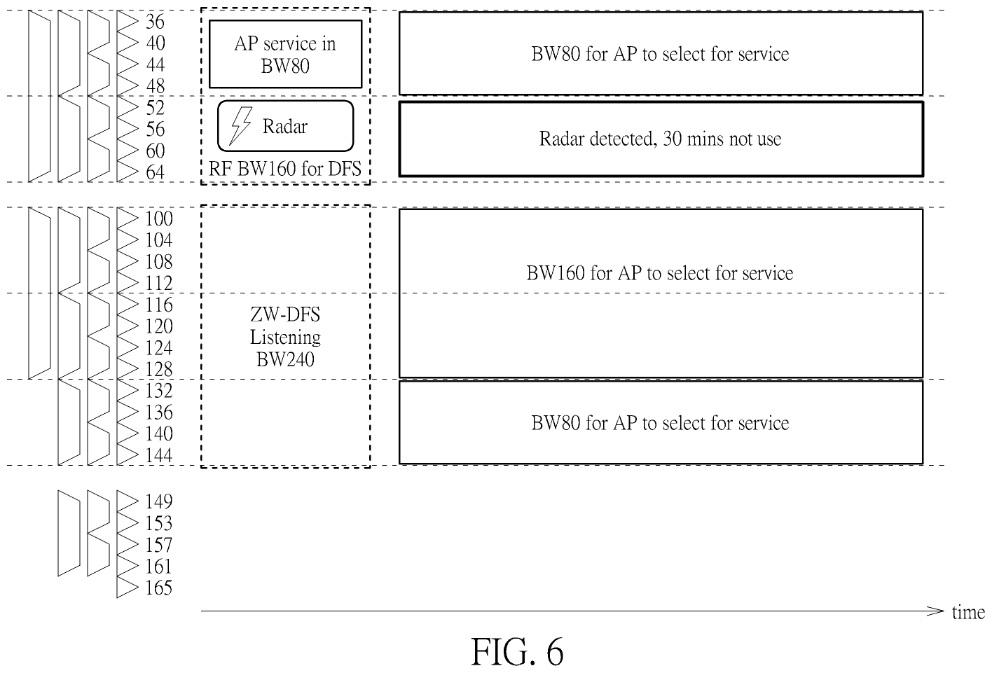

FIG. 6 is a diagram illustrating operations of the AP 100 according to a third embodiment of the present invention. As shown in FIG. 6, assuming that the AP 100 is just powered on, and initially the wireless communication circuit 120 starts to operate in a power-on mode. In the power-on mode, it is currently unclear whether there is a radar signal on the DFS channels, so the AP 100 uses a channel bot belonging to the DFS channels to communicate with the stations 102 and 104 (FIG. 6 shows that the channel having Wi-Fi sub-channels #36-#48 is used), and the wireless communication circuit 120 starts to perform a CAC process to detect if any radar signal appears in the DFS channels during a CAC period such as 60 seconds. Specifically, during the CAC period, the wireless communication circuit 120 receives a signal via the main antenna 132 to detect if a radar signal appears in the Wi-Fi sub-channels #52-#64, and the communication circuit 120 further receives a signal via the zero-wait antenna 134 to detect if a radar signal appears in the Wi-Fi sub-channels #100-#144. In this embodiment, the wireless communication circuit 120 detects that the Wi-Fi sub-channels #52-#64 have the radar signals within the CAC period, so the Wi-Fi sub-channels #52-#64 cannot be used to communicate with the stations 102 and 104 within the next 30 minutes. In addition, because the Wi-Fi sub-channels #100-#144 do not have the radar signals, the wireless communication circuit 120 can select the channel having Wi-Fi sub-channels #100-#128 with 160 MHz bandwidth, or the wireless communication circuit 120 can select the channel having Wi-Fi sub-channels #132-#144 with 80 MHz bandwidth, for communicating with the stations 102 and 104. In addition, after the CAC period, the wireless communication circuit 120 switches to the radar detection mode from the power-on mode, and the wireless communication circuit 120 continuously monitor the DFS channels to detect if any radar signal appears via the main antenna 132 and the zero-wait antenna 134.

In the embodiments shown in FIG. 3-FIG. 6, by detecting all the DFS channels within one CAC period, the wireless communication circuit 120 can quickly find all maximum available bandwidth in one CAC period, to select the appropriate channel efficiently to improve the throughput and spectrum of the AP 100. In addition, by using the main antenna 132 and the aero-wait antenna 134 for the detections of DFS channels simultaneously, the execution efficiency of the wireless communication circuit 120 can be increased without increasing the manufacturing cost too much.

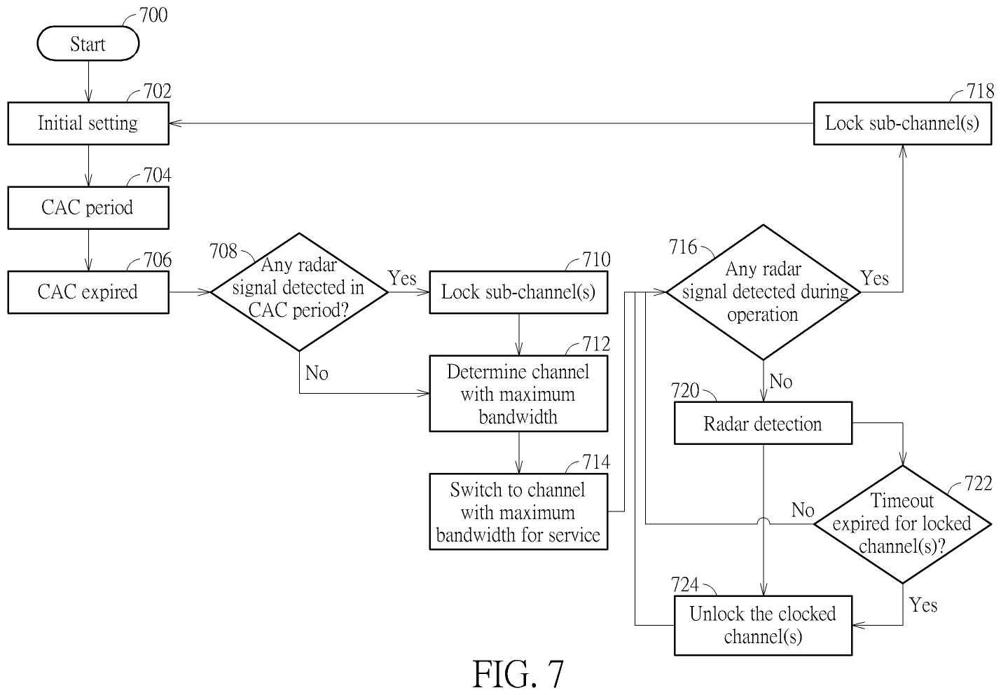

FIG. 7 is a diagram illustrating a control method of the AP 100 according to one embodiment of the present invention. In Step 700, the flow starts, and the AP 100 is powered on and complete the initialization process. In Step 702, the AP 100 uses an initial setting to establish a link with one or more stations such as 102 and 104 shown in FIG. 1, and uses the initial setting to communicate with the station(s). Specifically, referring to FIG. 3-FIG. 6, the AP 100 uses the initial channel having Wi-Fi sub-channels #36-#48 for the transmission/reception service, configures the main antenna 132 for radar signal detection on the channels #36-#64 with 160 MHz bandwidth or the channels #52-#64 with 80 MHz bandwidth, and configures the zero-wait antenna 134 for radar signal detection on the channels #100-#144 with 240 MHz bandwidth. In Step 704, the AP 100 starts to perform the CAC process to detect if any radar signal appears in the channels during a CAC period such as 60 seconds. In Step 706, the CAC process expired, and a radar detection result is obtained.

In Step 708, the AP 100 determines if any radar signal appears in the channels #36-#64 and the channels #100-#144 according to the radar detection result, if yes, the flow enters Step 710; and if not, the flow enters Step 712. In Step 710, the AP 100 locks the Wi-Fi sub-channel having radar signals, and the locked Wi-Fi sub-channel cannot be used in the next 30 minutes. In this embodiment, the AP 100 has a plurality of hit-indicator stored in the internal buffer, each hit-indicator corresponds to one Wi-Fi sub-channel (20 MHz bandwidth), and the hit-indicator is used to indicate if the corresponding Wi-Fi sub-channel is locked. In Step 712, the AP 100 selects the channel having maximum bandwidth from a plurality of available channels. In this embodiment, after the CAC period, the AP 100 establishes an available channel list comprises available channels with 240 MHz bandwidth, 160 MHz bandwidth, 80 MHz bandwidth, 40 MHz bandwidth and 20 MHz bandwidth. Specifically, if the radar detection result or the hit-indicators indicate that all of the Wi-Fi sub-channels #100-#144 do not have the radar signals, the channel having Wi-Fi sub-channels #100-#144 with 240 MHz bandwidth is an available channel. If the radar detection result or the hit-indicators indicate that all of the Wi-Fi sub-channels #36-#64 do not have the radar signals, the channel having Wi-Fi sub-channels #36-#64 with 160 MHz bandwidth is an available channel. If the radar detection result or the hit-indicators indicate that all of the Wi-Fi sub-channels #100-#128 do not have the radar signals, the channel having Wi-Fi sub-channels #100-#128 with 160 MHz bandwidth is an available channel. If the radar detection result or the hit-indicators indicate that all of the Wi-Fi sub-channels #52-#64 do not have the radar signals, the channel having Wi-Fi sub-channels #52-#64 with 80 MHz bandwidth is an available channel. If the radar detection result or the hit-indicators indicate that all of the Wi-Fi sub-channels #100-#112 do not have the radar signals, the channel having Wi-Fi sub-channels #100-#112 with 80 MHz bandwidth is an available channel. If the radar detection result or the hit-indicators indicate that all of the Wi-Fi sub-channels #116-#128 do not have the radar signals, the channel having Wi-Fi sub-channels #116-#128 with 80 MHz bandwidth is an available channel. If the radar detection result or the hit-indicators indicate that all of the Wi-Fi sub-channels #132-#144 do not have the radar signals, the channel having Wi-Fi sub-channels #132-#144 with 80 MHz bandwidth is an available channel. Similarly, the available channels with 40 MHz bandwidth and 20 MHz bandwidth are determined based on the radar detection result or the hit-indicators.

In Step 712, the AP 100 switches to the selected channel from the initial channel having Wi-Fi sub-channels #36-#48, and uses the selected channel to communicate with the station(s) via the main antenna 132. In Step 716, the AP 100 continuously uses the main antenna 132 and the zero-wait antenna 134 to detect if any radar signal appears in the Wi-Fi sub-channels #36-#144, and if any radar signal is detected, the flow enters Step 718; and if no radar signal is detected, the flow enters Step 720.

In Step 718, the AP 100 locks the Wi-Fi sub-channel having radar signals, wherein the locked Wi-Fi sub-channel cannot be used in the next 30 minutes. Then, the flow goes back to Step 702.

In Step 720, the AP 100 continuously uses the main antenna 132 and the zero-wait antenna 134 to detect if any radar signal appears in the Wi-Fi sub-channels #36-#144.

In Step 722, the AP 100 determines if a timeout expired for the locked Wi-Fi sub-channel(s), that is, whether the locked channel has not been used for 30 minutes. If yes, the flow enters Step 724; and if not, the flow enters Step 716.

In Step 724, the AP 100 unlocks the locked channel(s), and these unlocked channel(s) become available channels for the communications with the station(s). Then, the flow goes back to Step 716.

Briefly summarized, in the control method of the AP of the present invention, by detecting all the DFS channels within only one CAC period, the AP can quickly find all maximum available bandwidth after the CAC period, to select the appropriate channel efficiently to improve the throughput and spectrum of the AP. In addition, by using the main antenna and the zero-wait antenna for the detections of DFS channels simultaneously, the execution efficiency of the AP can be increased without increasing the manufacturing cost too much.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an electronic device, wherein the electronic device comprises a first antenna group and a second antenna, and the control method comprises:
using a first channel to communicate with other electronic device(s) via the first antenna group;
performing a channel availability check (CAC) process to detect if any radar signal appears in all dynamic frequency selection (DFS) channels in a 5 GHz band during a CAC period by using at least the second antenna, to generate a radar detection result; and
determining a second channel according to the radar detection result, and using the second channel to communicate with the other electronic device(s) via the first antenna group.

2. The control method of claim 1, wherein the step of performing the CAC process to detect if any radar signal appears in all the DFS channels in the 5 GHz band during the CAC period by using at least the second antenna, to generate the radar detection result comprises:
performing the CAC process to detect if any radar signal appears in all the DFS channels during the CAC period by using both the first antenna group and the second antenna, to generate the radar detection result.

3. The control method of claim 2, wherein the step of performing the CAC process to detect if any radar signal appears in all the DFS channels in the 5 GHz band during the CAC period by using both the first antenna group and the second antenna, to generate the radar detection result comprises:
performing the CAC process to detect if any radar signal appears in a first portion of the DFS channels during the CAC period by using the first antenna group; and
performing the CAC process to detect if any radar signal appears in a second portion of the DFS channels during the CAC period by using the second antenna, wherein the first portion of the DFS channels is different from the second portion of the DFS channels, and a combination of the first portion of the DFS channels and the second portion of the DFS channels is all the DFS channels in the 5 GHz band.

4. The control method of claim 3, wherein the second portion of the DFS channels has a 240 MHz bandwidth.

5. The control method of claim 4, wherein the first portion of the DFS channels has a 80 MHz bandwidth.

6. The control method of claim 3, wherein the second portion of the DFS channels comprises 20 MHz Wi-Fi sub-channels #100-#144.

7. The control method of claim 3, wherein the first portion of the DFS channels comprises 20 MHz Wi-Fi sub-channels #52-#64.

8. The control method of claim 1, wherein the step of determining the second channel according to the radar detection result, and using the second channel to communicate with the other electronic device(s) via the first antenna group comprises:
determining a plurality of available channels with different bandwidths according to the radar detection result;
selecting the second channel having a maximum bandwidth from the plurality of available channels; and
using the second channel to communicate with the other electronic device(s) via the first antenna group.

9. A control method of an electronic device, wherein the electronic device comprises a first antenna group and a second antenna, and the control method comprises:
using a first channel to communicate with other electronic device(s) via the first antenna group;
performing a channel availability check (CAC) process to detect if any radar signal appears in at least a portion of dynamic frequency selection (DFS) channels in a 5 GHz band during a CAC period by using the second antenna, to generate a radar detection result, wherein at least the portion of DFS channels in the 5 GHz band has at least 240 MHz bandwidth; and
determining a second channel according to the radar detection result, and using the second channel to communicate with the other electronic device(s) via the first antenna group.

10. The control method of claim 9, wherein at least the portion of DFS channels in the 5 GHz band comprises 20 MHz Wi-Fi sub-channels #100-#144.

11. The control method of claim 9, wherein the at least the portion of DFS channels in the 5 GHz band comprises 20 MHz Wi-Fi sub-channels #52-#144.

12. The control method of claim 9, wherein the step of determining the second channel according to the radar detection result, and using the second channel to communicate with the other electronic device(s) via the first antenna group comprises:
determining a plurality of available channels with different bandwidths according to the radar detection result;
selecting the second channel having a maximum bandwidth from the plurality of available channels; and
using the second channel to communicate with the other electronic device(s) via the first antenna.

13. An electronic device, comprising a first antenna group, a second antenna and a wireless communication circuit, and the wireless communication circuit is configured to perform the steps of:
using a first channel to communicate with other electronic device(s) via the first antenna group;
performing a channel availability check (CAC) process to detect if any radar signal appears in all dynamic frequency selection (DFS) channels in a 5 GHz band during a CAC period by using at least the second antenna, to generate a radar detection result; and
determining a second channel according to the radar detection result, and using the second channel to communicate with the other electronic device(s) via the first antenna group.

14. The electronic device of claim 13, wherein the step of performing the CAC process to detect if any radar signal appears in all the DFS channels in the 5 GHz band during the CAC period by using at least the second antenna, to generate the radar detection result comprises:
performing the CAC process to detect if any radar signal appears in all the DFS channels during the CAC period by using both the first antenna group and the second antenna, to generate the radar detection result.

15. The electronic device of claim 14, wherein the step of performing the CAC process to detect if any radar signal appears in all the DFS channels in the 5 GHz band during the CAC period by using both the first antenna group and the second antenna, to generate the radar detection result comprises:
performing the CAC process to detect if any radar signal appears in a first portion of the DFS channels during the CAC period by using the first antenna group; and
performing the CAC process to detect if any radar signal appears in a second portion of the DFS channels during the CAC period by using the second antenna, wherein the first portion of the DFS channels is different from the second portion of the DFS channels, and a combination of the first portion of the DFS channels and the second portion of the DFS channels is all the DFS channels in the 5 GHz band.

16. The electronic device of claim 15, wherein the second portion of the DFS channels has a 240 MHz bandwidth.

17. The electronic device of claim 16, wherein the first portion of the DFS channels has a 80 MHz bandwidth.

18. The electronic device of claim 15, wherein the second portion of the DFS channels comprises 20 MHz Wi-Fi sub-channels #100-#144.

19. The electronic device of claim 15, wherein the first portion of the DFS channels comprises 20 MHz Wi-Fi sub-channels #52-#64.

20. The electronic device of claim 13, wherein the step of determining the second channel according to the radar detection result, and using the second channel to communicate with the other electronic device(s) via the first antenna group comprises:
determining a plurality of available channels with different bandwidths according to the radar detection result;
selecting the second channel having a maximum bandwidth from the plurality of available channels; and
using the second channel to communicate with the other electronic device(s) via the first antenna group.
